(19) United States
(12) Patent Application Publication
(10) Pub. No.: US 2026/0370264 A1
(43) Pub. Date: Nov. 19, 2026

(54) Control of Reflection Properties of a Reconfigurable Intelligent Surface

(71) Applicant: Telefonaktiebolaget LM Ericsson (publ), Stockholm (SE)

(72) Inventors: Rickard Ljung, Helsingborg (SE); Henrik Sjöland, Lund (SE); Mojtaba Mahdavi, Lund (SE); Shousheng He, Södra Sandby (SE); Magnus Olsson, Klagshamn (SE)

(21) Appl. No.: 19/155,309

(22) PCT Filed: Mar. 9, 2023
(86) PCT No.: PCT/EP2023/056051

§ 371 Date: Aug. 11, 2025

(51) Int. Cl. H04B 7/04

(52) U.S. Cl. CPC H04B 7/04013

(57) ABSTRACT

There is provided techniques for controlling reflection properties of an RIS. A method is performed by an RIS controller entity. The method comprises receiving request signals from UEs for wireless signals as transmitted and/or received by the UEs to be reflected by the RIS. The method comprises controlling the reflection properties of the RIS to reflect beams of wireless signals as transmitted and/or received only by a first subset of the UEs for which angles of arrival of the request signals and a measured signal property of the request signals fulfil a priority condition.

### TECHNICAL FIELD

Embodiments presented herein relate to a method, a reconfigurable intelligent surface controller entity, a computer program, and a computer program product for controlling reflection properties of a reconfigurable intelligent surface.

### BACKGROUND

A reconfigurable intelligent surface (RIS) offers an opportunity for improved wireless communication. Specifically, significant gains are envisioned to be made for millimetre wave spectrum, which is used in fifth generation and sixth generation telecommunication systems. This spectrum has serious challenges when it comes to propagation and coverage, e.g., due to its very high frequency ranges in tens of GHz. The challenges are larger compared to challenges for spectrum with lower frequencies e.g., for so-called sub-6 GHZ frequency bands.

RISs represent an emerging technology that is capable of intelligently manipulating the propagation of electro-magnetic waves. A RIS is commonly also referred to as a large intelligent surface, a smart reflect-array, an intelligent reflecting surface, a passive intelligent mirror, an artificial radio space, and a meta-surface.

In general terms, a RIS is composed of a 2-dimensional array of reflecting antenna elements, such as patch antennas, where each antenna element acts as a passive reconfigurable scatterer, i.e., a piece of manufactured material, which can be configured to change (the beam of) an impinging electro-magnetic wave in a customizable way. Such antenna elements are commonly provided as low-cost passive surfaces that do not require dedicated power sources, and the radio waves impinged upon them can be forwarded without the need of employing power amplifier or radio chain. Moreover, a RIS can, potentially, operate in full duplex mode without significant self-interference or increased noise level and requires only low-rate control link or backhaul connections. A RIS can be flexibly deployed due to its low weight and low power consumption.

It is hereinafter assumed that the activation and deactivation of the RIS is requested by user equipment (UEs), meaning the network nodes (such as base stations) in the network do not require to control the RIS. In other words, a UE will need to send some kind of request signal to the RIS for the RIS to start supporting the UE by reflecting beams of wireless signals as transmitted and/or received by the UE.

WO2021260047A1 teaches a RIS to detect a direction towards a UE. The RIS receives a reference signal from the UE and determines an estimated angle-of-arrival and re-configures itself based on the estimated angle-of-arrival.

However, it could be that a plurality of UEs sends such request signals within some given time interval, or that one UE sends a plurality of request signals for the UE to be continuously supported by the RIS. In such cases there is a risk that the RIS will be overloaded with request signals, or at least that the RIS will not be able to support all UEs from which request signals are received.

### SUMMARY

An object of embodiments herein is to address the above issues.

A particular object is to enable the RIS to select which one or more UEs that is/are to be supported by the RIS.

According to a first aspect there is presented an RIS controller entity for controlling reflection properties of an RIS. The RIS controller entity comprises processing circuitry. The processing circuitry is configured to cause the RIS controller entity to receive request signals from UEs for wireless signals as transmitted and/or received by the UEs to be reflected by the RIS. The processing circuitry is configured to cause the RIS controller entity to control the reflection properties of the RIS to reflect beams of wireless signals as transmitted and/or received only by a first subset of the UEs for which angles of arrival of the request signals and a measured signal property of the request signals fulfil a priority condition.

According to a second aspect there is presented an RIS controller entity for controlling reflection properties of an RIS. The RIS controller entity comprises a receive module configured to receive request signals from UEs for wireless signals as transmitted and/or received by the UEs to be reflected by the RIS. The RIS controller entity comprises a control module configured to control the reflection properties of the RIS to reflect beams of wireless signals as transmitted and/or received only by a first subset of the UEs for which angles of arrival of the request signals and a measured signal property of the request signals fulfil a priority condition.

According to a third aspect there is presented a method for controlling reflection properties of an RIS. The method is performed by an RIS controller entity. The method comprises receiving request signals from UEs for wireless signals as transmitted and/or received by the UEs to be reflected by the RIS. The method comprises controlling the reflection properties of the RIS to reflect beams of wireless signals as transmitted and/or received only by a first subset of the UEs for which angles of arrival of the request signals and a measured signal property of the request signals fulfil a priority condition.

According to a fourth aspect there is presented a computer program for controlling reflection properties of an RIS. The computer program comprises computer code which, when run on processing circuitry of an RIS controller entity, causes the RIS controller entity to perform actions. One action comprises the RIS controller entity to receive request signals from UEs for wireless signals as transmitted and/or received by the UEs to be reflected by the RIS. One action comprises the RIS controller entity to control the reflection properties of the RIS to reflect beams of wireless signals as transmitted and/or received only by a first subset of the UEs for which angles of arrival of the request signals and a measured signal property of the request signals fulfil a priority condition.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects resolve the above issues.

Advantageously, these aspects enable the RIS controller entity to select which one or more UEs that is/are to be supported by the RIS.

Advantageously, the selection can be made by the RIS controller entity without the UEs providing any specific information in the request signals except that the UEs request the RIS to be activated to reflect beams of wireless signals as transmitted and/or received by the UEs.

Advantageously, these aspects therefore do not require any modification of the functionality of the UEs.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2 is a schematic diagram illustrating an RIS according to embodiments;

FIGS. 3 and 4 are flowcharts of methods according to embodiments;

FIG. 5 is a schematic diagram showing functional units of an RIS controller entity according to an embodiment;

FIG. 6 is a schematic diagram showing functional modules of an RIS controller entity according to an embodiment; and

FIG. 7 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

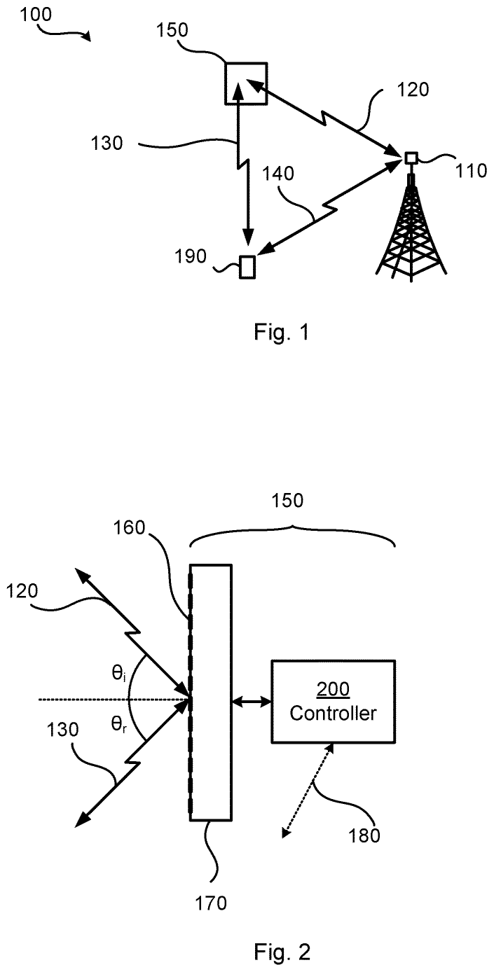

FIG. 1 is a schematic diagram illustrating a communication network 100 where a RIS 150 is shown as assisting communication between a network node 110 and a UE 190 over wireless links 120, 130, 140. In this respect, the UE 190 and the network node 110 communicate over a direct link, as represented by wireless link 140, and an indirect link via the RIS 150, as represented by wireless links 120, 130. In some examples the network node 110 is a transceiver point, an access point, an integrated access and backhaul node, a base station, a repeater, a gNB, or the like.

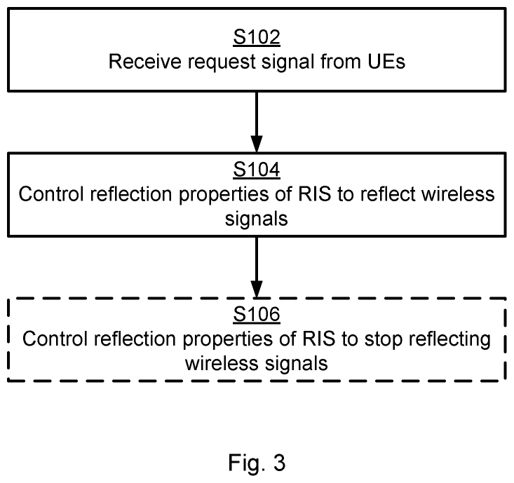

FIG. 2 is a schematic illustration of an example RIS 150. The RIS 150 comprises a controller entity 200 and a reflector entity 170, comprising a meta-surface or other type of array structure with reflecting antenna elements 160. The controller entity 200 is configured to control the reflection angle of the reflector entity 170 for reflecting radio waves over the indirect wireless link 120, 130 between the network node 110 and the UE 190. The controller entity 200 further is provided with transceiver circuitry for communicating with the UE 190 over a control channel (as indicated by the wireless link 180 regarding whether or not the RIS 150 should assist the UE 190 for communication with the network node 110. In further detail, by the controller entity 200 controlling the impedances of the respective reflecting antenna elements 160, the reflection angle θr of an incoming radio wave, or beam, having an angle of incidence θi, can be adapted according to the generalized Snell's law. FIG. 2 only illustrates one example implementation of the RIS 150 and the implementation might differ dependent on the type of RIS 150. Usage of the RIS 150 can vary, but in general the RIS can be configured to reflect wireless signals in a controlled manner, e.g., to steer transmitted signals in a certain direction. This could for example be used to improve overall system coverage, range, and efficiency.

As noted above, there is a risk that the RIS 150 (or actually the RIS controller entity 200) will be overloaded with request signals, or at least that the RIS 150 (or actually the RIS controller entity 200) will not be able to support all UEs 190 from which request signals are received.

As further noted above, this is due to the fact that a plurality of UEs 190 sends such request signals within some given time interval, or that one UE 190 sends a plurality of request signals for the UE 190 to be continuously supported by the RIS 150.

One way to address this issue is to enable the RIS controller entity 200 to make a selection among the UEs 190 from which request signals are received regarding which one or more UE 190 that the RIS 150 should support by reflecting beams of wireless signals as transmitted and/or received by this one or more UE 190. This requires on the one hand that suitable selection criteria can be identified and on the other hand that the selection criteria can actually be evaluated.

The embodiments disclosed herein therefore relate to techniques for controlling reflection properties of an RIS 150. In order to obtain such techniques, there is provided an RIS controller entity 200, a method performed by the RIS controller entity 200, a computer program product comprising code, for example in the form of a computer program, that when run on an RIS controller entity 200, causes the RIS controller entity 200 to perform the method.

At least some of the herein disclosed embodiments are based on that the RIS controller entity 200 collects information from request signals received from UEs 190 and monitors the concurrent need from them (where the concurrent need could be defined by the number of request signals received by the RIS controller entity 200 within some monitoring time widow). By taking information from the request signals into account, a selection is then performed by the RIS controller entity 200 to determine which UE(s) 190 that should be supported by the RIS 150.

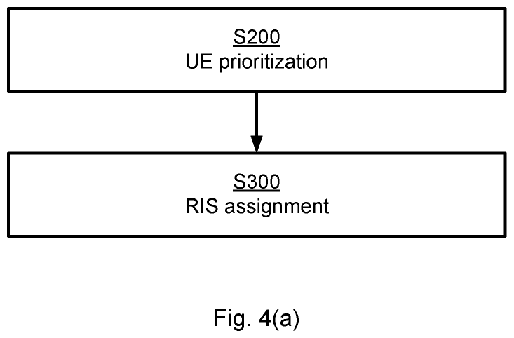

FIG. 3 is a flowchart illustrating embodiments of methods for controlling reflection properties of an RIS 150. The methods are performed by the RIS controller entity 200. The methods are advantageously provided as computer programs 720.

S102: The RIS controller entity 200 receives request signals from UEs 190 for wireless signals as transmitted and/or received by the UEs 190 to be reflected by the RIS 150.

In general terms, the wireless signals as transmitted and/or received by the UEs 190 are to be reflected by the RIS 150 in a direction towards the network node 110.

The selection of which UE(s) 190 that should be supported by the RIS 150 takes into account angle of arrival per received request signal and signal priority per request signal, wherein both these quantities are determined based on the request signals as received by the RIS controller entity 200.

S104: The RIS controller entity 200 controls the reflection properties of the RIS 150 to reflect beams of wireless signals as transmitted and/or received only by a first subset of the UEs 190 for which angles of arrival of the request signals and a measured signal property of the request signals fulfil a priority condition.

In general terms, the reflection properties of the RIS 150 are controlled such that the wireless signals as transmitted and/or received by the first subset of the UEs 190 are to be reflected by the RIS 150 in a direction towards the network node 110.

In general terms, in S104 the reflection properties are determined based on the angle of arrivals of the request signals as received from the UEs in the first subset of the UEs.

Advantageously, this method resolves the above issues.

Advantageously, this method enables the RIS controller entity to select which one or more UEs that is/are to be supported by the RIS.

Advantageously, the selection can be made by the RIS controller entity without the UEs providing any specific information in the request signals except that the UEs request the RIS to be activated to reflect beams of wireless signals as transmitted and/or received by the UEs.

Advantageously, this method therefore does not require any modification of the functionality of the UEs.

Embodiments relating to further details of controlling reflection properties of an RIS 150 as performed by the RIS controller entity 200 will now be disclosed with continued reference to FIG. 3.

In some aspects, the angle of arrival information for a given UE 190 and the measured signal property for the same given UE 190 result in a priority score for this given UE 190.

That is, in some embodiments, the angle of arrival of the request signal for a given UE 190 and the measured signal property for the given UE 190 yield a priority score for the given UE 190. In this way, one priority score can be determined for each UE 190 from which a respective request signal is received in S102.

In some aspects, the priority score needs to be higher than some threshold value for the priority condition to be fulfilled. That is, in some embodiments, the priority condition for the given UE 190 is only fulfilled when the priority score for the given UE 190 is higher than a threshold score.

In some examples, the RIS controller entity 200 selects the UE 190 with the highest priority score among the candidate UEs from which a respective request signal is received in S102. In this way, the UEs 190 are supported by the RIS 150 in a strict priority manner.

In some aspects the measured signal property is related to the signal strength and/or signal quality of the received request signals. The signal strength and/or signal quality can thus be used to determine the priority score. In terms of signal strength and/or signal quality, it is better if the signal strength and/or signal quality for the UE 190 is high than if the signal strength and/or signal quality for the UE 190 is low. That is, the higher signal strength and/or signal quality for the request signal received from the given UE 190 is, the higher the priority score is for the given UE 190.

In terms of the angle of arrival, it is better if the UE 190 is located more in front of the RIS 150 than to the side of the RIS 150. That is, the smaller the angle of arrival of the request signal for the given UE 190 is with respect to a normal direction of RIS 150, the higher the priority score could be for the given UE 190.

The RIS 150 might at the same time support multiple UEs 190 if these multiple UEs 190 are within close proximity of each other. Therefore, the smaller the difference in angle of arrival between two UEs 190 is, the higher the priority scores will be for these two UEs 190. In this manner the RIS 150 will be able to support UEs 190 not only where the demand, or priority, is high, but also based on the direction information. For example, multiple UEs 190 can be supported by the RIS 150 at the same time if the required configuration of the reflector entity 170 of the RIS 150 based on the angle information is similar for these multiple UEs 190. In other words, the reflections of transmissions are in practice directing signals to support transmissions to and from the geographic area of where the UEs 190 are currently located. If multiple UEs 190 are within close proximity of each other, it may be the case that the RIS 150 can with no, or just minor, panel configuration modifications support multiple UEs 190 with enhanced signal reflections at the same time.

It is foreseen that it could be so that the RIS 150 is already supporting some first group of UEs when the RIS controller entity 200 determines that some second group of UEs instead should be supported by the RIS 150. This could, for example, be the case where the priority scores for the UEs in the second group of UEs are higher than the priority scores for the UEs in the first group of UEs. Therefore, in some embodiments, the RIS controller entity 200 is configured to perform (optional) step S106.

S106: The RIS controller entity 200 controls the reflection properties of the RIS 150 to stop reflecting the wireless signals as transmitted and/or received by a second subset of the UEs 190 for which angles of arrival of the request signals and a measured signal property of the request signals fulfil the priority condition, but for which the priority scores are lower than the priority scores for the first subset of the UEs 190.

In some examples, the request signals comprise only the minimum information needed to indicate to the RIS controller entity 200 that the UEs 190 request the RIS 150 to be activated to reflect beams of wireless signals as transmitted and/or received by the UEs 190. In other examples, the request signals comprise additional information that can be useful by the RIS controller entity 200 when determining whether the RIS 150 is to be activated to reflect beams of wireless signals as transmitted and/or received by the UEs 190. In this respect, in some examples, the request signals comprise information of any, or any combination of: communication requirement for applications run in the UEs 190, support in the UEs 190 for multipath wireless communication, requested time interval during which the wireless signals as transmitted and/or received by the UEs 190 are to be reflected by the RIS 150, radio environment conditions, network operator information. The priority condition for a given UE 190 can then be based on one or more of these pieces of information for this given UE 190. An activation for reflection may in some examples be performed by adjusting one or more antenna elements in the RIS 150 to adjust the signal reflections in a direction towards the UE 190 or via further reflections on objects that enhances the communication path for the UE 190. An activation for reflection may in some examples be performed by adjusting one or more antenna elements in the RIS 150 to adjust the signal reflections in a direction towards a network node 110 with which the UE 190 is communicating.

In some examples, the communication requirement pertains to any, or any combination of: a service requirement of the applications, wireless communication protocol requirement for the transmission and/or reception of the wireless signals, current radio resource control (RRC) states of the UEs 190. In this respect, the priority condition for a given UE 190 could then be so that the priority score is higher for applications with real-time service requirements than for applications without real-time requirements. Further, the priority condition for a given UE 190 could be so that the priority score is higher for emergency service applications than for non-emergency service applications. Further, the priority condition for a given UE 190 could be so that the priority score is higher for a UE 190 that is in an RRC connected state than for a UE 190 that is not in an RRC connected state. Further, the priority condition for a given UE 190 could be so that the priority score is higher for a UE 190 that has low-latency wireless communication protocol requirements than for a UE 190 that does not have low-latency wireless communication protocol requirements, etc. Further, the communication requirement might indicate time information, e.g. a requested time window of RIS support, time slot information, such as time division duplex (TDD) allocation, etc. The RIS controller entity 200 could then use this information to see if any other UE 190 is supported by the RIS 150 during the requested time window or time slot, etc.

In some examples, the support in the UEs 190 for multipath wireless communication pertains to any, or any combination of: number of antennas at the UEs 190 available for the multipath wireless communication, availability of modems in the UEs 190 for performing the multipath wireless communication, availability of processing capability in the UEs 190 for processing the wireless signals. In this respect, the priority condition for a given UE 190 could then be so that the priority score is higher for a UE 190 that supports a multiple-input multiple-output (MIMO) rank x1 than for a UE 190 that supports a MIMO rank x2 if x1>x2. Likewise, the priority condition for a given UE 190 could then be so that the priority score increases with increased availability of processing capability at the UE 190, etc.

In some further examples, the support in the UEs 190 for multipath wireless communication pertains to any, or any combination of: number of available radio frequency chains in the UEs 190, number of communication layers supported by the UEs 190, MIMO ranks used by the UEs 190, multipath wireless communication protocols supported by the UEs 190. In this respect, the priority condition for a given UE 190 could then be so that the priority score is higher for a UE 190 that has y1 available radio frequency chains than for a UE 190 that has y2 available radio frequency chains if y1>y2. Likewise, the priority condition for a given UE 190 could then be so that the priority score increases with increased number of supported communication layers by the UE 190, etc.

In some examples, the radio environment conditions pertain to any, or any combination of: radio conditions of direct links between the UEs 190 and network nodes 110 serving the UEs 190. Information on the network infrastructure, e.g., which network operator the UEs utilizes can be useful for the RIS 150 to support reflections in the direction of a network node 110 of a certain network operator. Further, the RIS 150 might be configured to support UEs 190 served only by some network operators.

One alternative to the above embodiments is to randomly select which UEs 190 to be supported by the RIS 150. With such randomization, a first prioritization can be made by determining that valid request signals are received from one or more UEs 190, meaning that the priority value is binary-valued. Such binary characteristics can then be used by the RIS controller entity 200 to determine that all request signals that can be demodulated and detected by the RIS controller entity 200 are valid. Among all valid request signals the RIS controller entity 200 might then perform a random selection for which UEs 190 to be supported by the RIS 150.

One particular embodiment, as based on the above disclosed embodiments, aspects, and examples, for the RIS controller entity 200 to control reflection properties of the RIS 150 will be disclosed next with reference to the flowchart FIG. 4. In FIG. 4 is provided a method for how to assign one or more available RISs 150 to UEs 190. It is assumed that the RIS controller entity 200 has the knowledge of the number of available RISs 150 within a certain zone (e.g., a picocell or another area, defined for the network, is considered as a zone). Having considered a certain zone, multiple UEs 190 may send request signals to the RIS controller entity 200 to be supported by the one or more RISs 150. In FIG. 4(a) is shown the main steps S200 and S300. In FIG. 4(b) is shown the details of step S200 and in FIG. 4(c) is shown the details of step S300.

The main steps will be disclosed next with reference to FIG. 4(a).

S200: The RIS controller entity 200 prioritizes request signals as received from multiple UEs 190.

S300: The RIS controller entity 200 selects which of the multiple UEs 190 to be supported by the RIS 150. The selection is made based on the prioritization in step S200 and availability of the RIS 150.

Details of step S200 will be disclosed next with reference to FIG. 4(b).

S201: The controller entity 200 receives request signals as received from multiple UEs 190.

S202: The controller entity 200 checks one or more priority conditions for each of the UEs 190 based on the received request signals in order to categorize the UEs 190.

S203: UEs 190 considered to have high priority are put in a first first-in first-out buffer (FIFO1). These could be UEs that do not have any direct link to the network node 110.

S204: UEs 190 considered to not have high priority are put in a second first-in first-out buffer (FIFO2).

These could be UEs that already have a direct link to the network node 110, but that would still benefit from being supported by the RIS 150.

According to the functionality of a FIFO buffer, the first placed UE in FIFO1 has the highest probability of being supported by an RIS 150. Likewise, the last placed UE in FIFO2 has the lowest probability of being supported by an RIS 150.

Details of step S300 will be disclosed next with reference to FIG. 4(c).

S301: It is checked if FIFO1 is empty. If yes, step S307 is entered. Else, step S302 is entered.

S302: It is checked if an RIS becomes available. If yes, step S303 is entered. Else, step S304 is entered.

S303: The RIS is assigned to support the UE placed first in FIFO1. Then, this UE is removed from FIFO1 and step S301 is entered again.

S304: It is checked if a third FIFO buffer, FIFO3 is empty. If yes, step S305 is entered. Else, step S306 is entered.

S305: No further action is taken.

S306: An RIS assigned to supporting a UE in FIFO3 is released. Then, this UE is removed from FIFO3 and step S303 is entered.

Hence, if FIFO1 is not empty while there is no available RIS, the first UE in FIFO3 will be disconnected from being supported by an assigned RIS. Then, the released RIS will be assigned to the first UE in FIFO1. This is due to the fact that after disconnecting a UE in FIFO3 from an RIS panel, this UE still has another communication link with the network node while the UEs in FIFO1 do not yet have any established wireless link.

This process will be repeated for the remaining candidate UEs in FIFO1 until FIFO1 becomes empty. Then, the content of FIFO2 will be checked.

S307: It is checked if FIFO2 is empty. If yes, step S308 is entered. Else, step S309 is entered.

S308: No further action is taken.

S309: It is checked if an RIS becomes available. If yes, step S310 is entered. Else, step S308 is entered.

S310: The available RIS is assigned to support the UE placed first in FIFO2.

S311: The UE placed first FIFO2 is removed from FIFO2 and put first in FIFO3. Step S307 is then entered again.

Hence, if FIFO2 is not empty, any available RIS will be assigned to provide support for the UEs in FIFO2 until there are not any remaining available RISs. When there are no further available RISs, step S200 can be entered again, after some time delay.

It is noted that when an RIS is assigned to support a UE in FIFO2, this UE will be removed from FIFO2 and added to FIFO3. Thus, FIFO3 includes the UEs which have more than one wireless link and an RIS has already been assigned to support each of them.

In any scenario where there are some UEs in FIFO1 or FIFO2 but there is no available RIS as well as no possibility for releasing any RIS from UEs in FIFO3, no further action can be taken in S300 and therefore S200 could be entered again after some time delay.

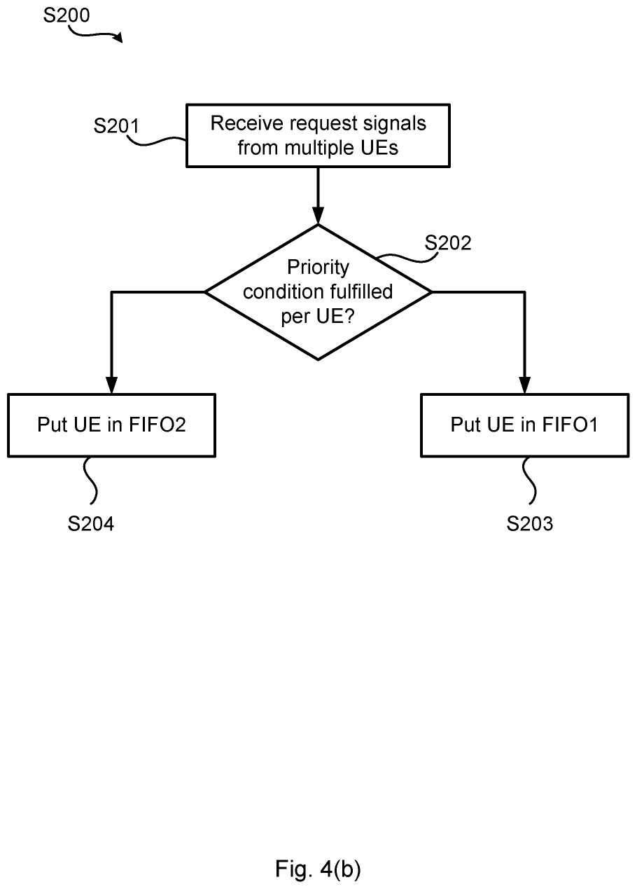

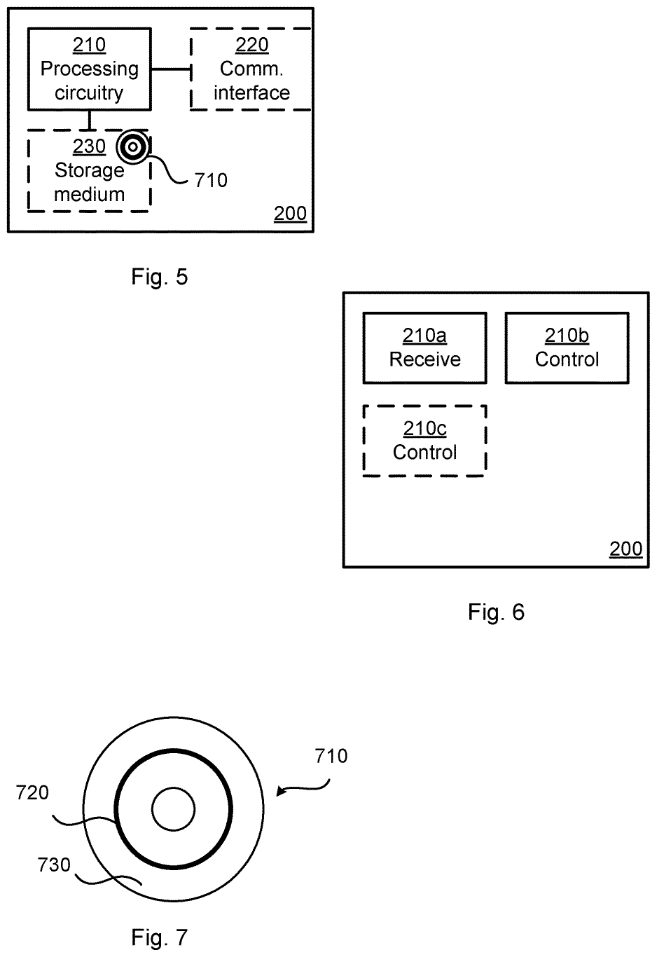

FIG. 5 schematically illustrates, in terms of a number of functional units, the components of an RIS controller entity 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 710 (as in FIG. 7), e.g. in the form of a storage medium 230. The processing circuitry 210 may further be provided as at least one application specific integrated circuit (ASIC), or field programmable gate array (FPGA).

Particularly, the processing circuitry 210 is configured to cause the RIS controller entity 200 to perform a set of operations, or steps, as disclosed above. For example, the storage medium 230 may store the set of operations, and the processing circuitry 210 may be configured to retrieve the set of operations from the storage medium 230 to cause the RIS controller entity 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The RIS controller entity 200 may further comprise a communications (comm.) interface 220 at least configured for communications with other entities, functions, nodes, and devices, as in FIG. 1 and FIG. 2. As such the communications interface 220 may comprise one or more transmitters and receivers, comprising analogue and digital components. The processing circuitry 210 controls the general operation of the RIS controller entity 200 e.g. by sending data and control signals to the communications interface 220 and the storage medium 230, by receiving data and reports from the communications interface 220, and by retrieving data and instructions from the storage medium 230. Other components, as well as the related functionality, of the RIS controller entity 200 are omitted in order not to obscure the concepts presented herein.

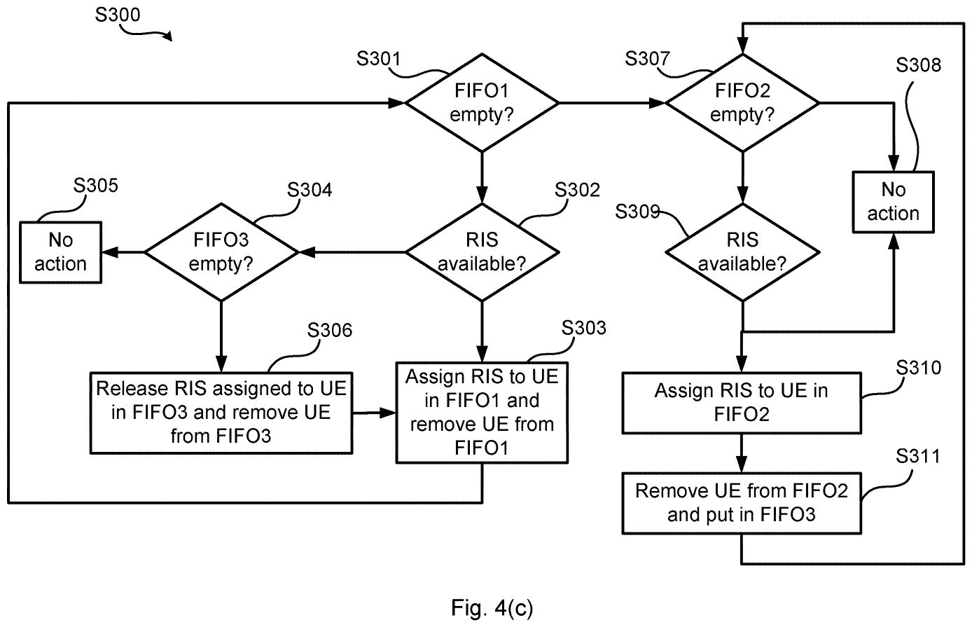

FIG. 6 schematically illustrates, in terms of a number of functional modules, the components of an RIS controller entity 200 according to an embodiment. The RIS controller entity 200 of FIG. 6 comprises a number of functional modules; a receive module 210a configured to perform step S102, and a control module 210b configured to perform step S104. The RIS controller entity 200 of FIG. 6 may further comprise a number of optional functional modules, such as a control module 210c configured to perform step S106. In general terms, each functional module 210a: 210c may in one embodiment be implemented only in hardware and in another embodiment with the help of software, i.e., the latter embodiment having computer program instructions stored on the storage medium 230 which when run on the processing circuitry makes the RIS controller entity 200 perform the corresponding steps mentioned above in conjunction with FIG. 6. It should also be mentioned that even though the modules correspond to parts of a computer program, they do not need to be separate modules therein, but the way in which they are implemented in software is dependent on the programming language used. Preferably, one or more or all functional modules 210a: 210c may be implemented by the processing circuitry 210, possibly in cooperation with the communications interface 220 and/or the storage medium 230. The processing circuitry 210 may thus be configured to from the storage medium 230 fetch instructions as provided by a functional module 210a: 210c and to execute these instructions, thereby performing any steps as disclosed herein.

The RIS controller entity 200 may be provided as a standalone device or as a part of at least one further device. Thus, a first portion of the instructions performed by the RIS controller entity 200 may be executed in a first device, and a second portion of the of the instructions performed by the RIS controller entity 200 may be executed in a second device; the herein disclosed embodiments are not limited to any particular number of devices on which the instructions performed by the RIS controller entity 200 may be executed. Hence, the methods according to the herein disclosed embodiments are suitable to be performed by an RIS controller entity 200 residing in a cloud computational environment. Therefore, although a single processing circuitry 210 is illustrated in FIG. 5 the processing circuitry 210 may be distributed among a plurality of devices, or nodes. The same applies to the functional modules 210a:210c of FIG. 6 and the computer program 720 of FIG. 7.

FIG. 7 shows one example of a computer program product 710 comprising computer readable storage medium 730. On this computer readable storage medium 730, a computer program 720 can be stored, which computer program 720 can cause the processing circuitry 210 and thereto operatively coupled entities and devices, such as the communications interface 220 and the storage medium 230, to execute methods according to embodiments described herein. The computer program 720 and/or computer program product 710 may thus provide means for performing any steps as herein disclosed.

In the example of FIG. 7, the computer program product 710 is illustrated as an optical disc, such as a CD (compact disc) or a DVD (digital versatile disc) or a Blu-Ray disc. The computer program product 710 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 720 is here schematically shown as a track on the depicted optical disk, the computer program 720 can be stored in any way which is suitable for the computer program product 710.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1.-16. (canceled)

17. A reconfigurable intelligent surface (RIS) controller entity comprising processing circuitry configured to cause the RIS controller entity to:
receive, from one or more user equipment (UEs), respective request signals for wireless signals transmitted and/or received by the one or more UEs to be reflected by the RIS; and
based on the respective requests, control reflection properties of the RIS to reflect beams of the wireless signals transmitted and/or received by a first subset of the one or more UEs, wherein the first subset corresponds to UEs for which one or more of the following for the respective request signals fulfills a priority condition: angle of arrival with respect to a normal direction of RIS, and a measured signal property.

18. The RIS controller entity according to claim 17, wherein the angles of arrival with respect to a normal direction of RIS and the measured signal properties of the respective request signals yield respective priority scores for the one or more UEs.

19. The RIS controller entity according to claim 18, wherein for each of the one or more UEs, the priority condition is fulfilled only when the priority score for the UE is higher than a threshold score.

20. The RIS controller entity according to claim 18, wherein for each of the one or more UEs:
the priority score for the UE increases when the measured signal property of the request signal from the UE increases; and
the measured signal property of the request signal includes one or more of the following:
signal strength, and signal quality.

21. The RIS controller entity according to claim 18, wherein for each of the one or more UEs, the priority score for the UE increases when the angle of arrival of the request signal from the UE decreases with respect to the normal direction of RIS.

22. The RIS controller entity according to claim 18, wherein for first and second ones of the one or more UEs, the priority scores for the first and second UEs increase as a difference in the angles of arrival between the request signals from the first and second UEs decreases.

23. The RIS controller entity according to claim 18, wherein:
the processing circuitry is further configured to cause the RIS controller entity to control reflection properties of the RIS to stop reflection of beams of the wireless signals transmitted and/or received by a second subset of the one or more UEs; and
the second subset corresponds to UEs whose priority scores fulfill the priority condition but are less than the priority scores for the first subset.

24. The RIS controller entity according to claim 17, wherein each of the request signals includes or indicates one or more of the following information pertaining to the UE from which it was received:
communication requirement for applications run in the UE,
UE support for multipath wireless communication,
requested time interval during which the wireless signals as transmitted and/or received by the UE are to be reflected by the RIS,
radio environment conditions, and
network operator information,
wherein the priority condition for the UE is based on the information included with the request signal received from the UE.

25. The RIS controller entity according to claim 24, wherein the communication requirement for applications run in the UE pertains to one or more of the following: a service requirement of the applications, wireless communication protocol requirement for the transmission and/or reception of the wireless signals, and current radio resource control (RRC) state of the UE.

26. The RIS controller entity according to claim 24, wherein the indication of UE support for multipath wireless communication pertains to one or more of the following:
number of UE antennas available for the multipath wireless communication,
availability of modems in the UE for performing the multipath wireless communication,
availability of UE capability for processing the wireless signals,
number of available radio frequency chains in the UE,
number of communication layers supported by the UE,
ranks used by the UE, and
multipath wireless communication protocols supported by the UE.

27. The RIS controller entity according to claim 24, wherein indicated radio environment conditions pertain to one or more of the following: direct links with other UEs, and links with one or more network nodes serving the UE.

28. A computer-implemented method for controlling reflection properties of a reconfigurable intelligent surface (RIS), wherein the method is performed by an RIS controller entity and comprises:
receiving, from one or more user equipment (UEs), respective request signals for wireless signals transmitted and/or received by the one or more UEs to be reflected by the RIS; and
based on the respective requests, controlling reflection properties of the RIS to reflect beams of the wireless signals transmitted and/or received by a first subset of the one or more UEs, wherein the first subset corresponds to UEs for which one or more of the following for the respective request signals fulfills a priority condition: angle of arrival with respect to a normal direction of RIS, and a measured signal property.

29. The method according to claim 28, wherein the angles of arrival with respect to a normal direction of RIS and the measured signal properties of the respective request signals yield respective priority scores for the one or more UEs.

30. The method according to claim 29, wherein for each of the one or more UEs, the priority condition is fulfilled only when the priority score for the UE is higher than a threshold score.

31. The method according to claim 29, wherein for each of the one or more UEs:
the priority score for the UE increases when the measured signal property of the request signal from the UE increases; and
the measured signal property of the request signal includes one or more of the following:
signal strength, and signal quality.

32. The method according to claim 29, wherein for each of the one or more UEs, the priority score for the UE increases when the angle of arrival of the request signal from the UE decreases with respect to the normal direction of RIS.

33. The method according to claim 29, wherein for first and second ones of the one or more UEs, the priority scores for the first and second UEs increase as a difference in the angles of arrival between the request signals from the first and second UEs decreases.

34. The method according to claim 29, wherein:
the method further comprises controlling reflection properties of the RIS to stop reflection of beams of the wireless signals transmitted and/or received by a second subset of the one or more UEs; and
the second subset corresponds to UEs whose priority scores fulfill the priority condition but are less than the priority scores for the first subset.

35. The method according to claim 28, wherein each of the request signals includes or indicates one or more of the following information pertaining to the UE from which it was received:
communication requirement for applications run in the UE,
UE support for multipath wireless communication,
requested time interval during which the wireless signals as transmitted and/or received by the UE are to be reflected by the RIS,
radio environment conditions, and
network operator information,
wherein the priority condition for the UE is based on the information included with the request signal received from the UE.

36. A non-transitory, computer-readable medium having stored thereon computer program code that, when executed by processing circuitry of an reconfigurable intelligent surface (RIS) controller entity, causes the RIS controller entity to:
receive, from one or more user equipment (UEs), respective request signals for wireless signals transmitted and/or received by the one or more UEs to be reflected by the RIS; and
based on the respective requests, control reflection properties of the RIS to reflect beams of the wireless signals transmitted and/or received by a first subset of the one or more UEs, wherein the first subset corresponds to UEs for which one or more of the following for the respective request signals fulfills a priority condition: angle of arrival with respect to a normal direction of RIS, and a measured signal property.
